(19) United States
(12) Patent Application Publication
(10) Pub. No.: US 2015/0159729 A1
(43) Pub. Date: Jun. 11, 2015

(54) SUSPENSION ASSEMBLY FOR PAYLOAD CARRIER

(71) Applicant: Caterpillar Inc., Peoria, IL (US)

(72) Inventor: Nirmal Goldwin, Chennai (IN)

(73) Assignee: Caterpillar Inc., Peoria, IL (US)

(21) Appl. No.: 14/622,963

(22) Filed: Feb. 16, 2015

(51) Int. Cl. F16F 13/00

(52) U.S. Cl. CPC F16F 13/007

(57) ABSTRACT

A suspension assembly for a payload carrier includes an upper plate fixedly attached to a back wall of the payload carrier, and a lower plate positioned laterally spaced apart from the upper plate, the lower plate configured to move relative to the upper plate on exertion of an external force thereon. The suspension assembly also includes a damper assembly provided between the upper plate and the lower plate to dampen a transfer of the external force from the lower plate to the upper plate. The damper assembly includes a guiding element and a stopper element fixedly attached to at least one of the upper plate or the lower plate. The damper assembly further includes a spring member surrounding the guiding element, the spring member configured to compress under the external force. The damper assembly also includes a coupling mechanism configured to couple the lower plate with the upper plate.

### TECHNICAL FIELD

The present disclosure relates to a payload carrier of a work machine, and more particularly to a suspension assembly for the payload carrier.

### BACKGROUND

Machines, such as, a mining dump truck, include a payload carrier that is subject to multiple loading and unloading operations, due to which the payload carrier is raised and lowered a number of times with respect to a frame of the machine. The payload carrier is provided with resting points configured to seat on the frame of the machine. Such resting points include rigid metal plates welded onto the payload carrier. During the loading and unloading operation of the machine and sometimes during movement of the machine, forces and vibrations are transferred to the payload carrier through these resting points. The resting points being rigid in nature may lack flexibility, and are thus susceptible to vibrations and induced stresses developed in view of the exerted forces. This may lead to wear and tear of the payload carrier and may also lead to an increase in machine downtime. Further, this may also lead to an increase in turnaround time and overall costs, thereby leading to inefficiencies and less productivity.

Japanese Patent Publication 2007176251 relates to a body mount device of a dump truck. The dump truck includes a buffer member interposed between a bracket and a base portion of payload carrier of the dump truck. The buffer member has a cushioning action and has a structure including sandwiched sandwich-like elastic member such as rubber pads between steel plates. The publication does not disclose a flexible vibration damping type suspension assembly as mentioned in the present disclosure.

### SUMMARY OF THE DISCLOSURE

In one aspect of the present disclosure, a suspension assembly for a payload carrier is disclosed. The suspension assembly includes an upper plate fixedly attached to a back wall of the payload carrier. The suspension assembly also includes a lower plate positioned laterally spaced apart from the upper plate on the back wall of the payload carrier. The lower plate is configured to move relative to the upper plate. The suspension assembly further includes a damper assembly provided between the upper plate and the lower plate. The damper assembly includes a guiding element and a stopper element fixedly attached to at least one of the upper plate or the lower plate. The damper assembly further includes a spring member provided surrounding the guiding element. The guiding element is configured to guide a compression and extension of the spring member along a length of the guiding element. The damper assembly also includes a coupling mechanism provided between the lower plate and the upper plate, the coupling mechanism configured to couple the lower plate with the upper plate. The lower plate is configured to move towards the upper plate on exertion of an external force thereon, the external force contemporaneously causing a compression of the spring member along the length of the guiding element for moving the lower plate towards the upper plate by an effective height. The damper assembly is configured to dampen a transfer of the external force from the lower plate to the upper plate.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a perspective view of a payload carrier of the machine of FIG. 1, according to one embodiment of the present disclosure;

FIG. 3 is a perspective view of a suspension assembly employed on the payload carrier of FIG. 2, according to one embodiment of the present disclosure;

FIG. 4 is another perspective view of the suspension assembly of FIG. 3, according to one embodiment of the present disclosure;

FIG. 5 is a perspective view of a suspension assembly employed on the payload carrier of FIG. 2, according to another embodiment of the present disclosure;

FIG. 6 is a is another perspective view of the suspension assembly of FIG. 5, according to one embodiment of the present disclosure;

FIG. 7 is a perspective view of a suspension assembly employed on the payload carrier of FIG. 2, according to a yet another embodiment of the present disclosure; and

FIG. 8 is another perspective view of the suspension assembly of FIG. 7, according to one embodiment of the present disclosure.

### DETAILED DESCRIPTION

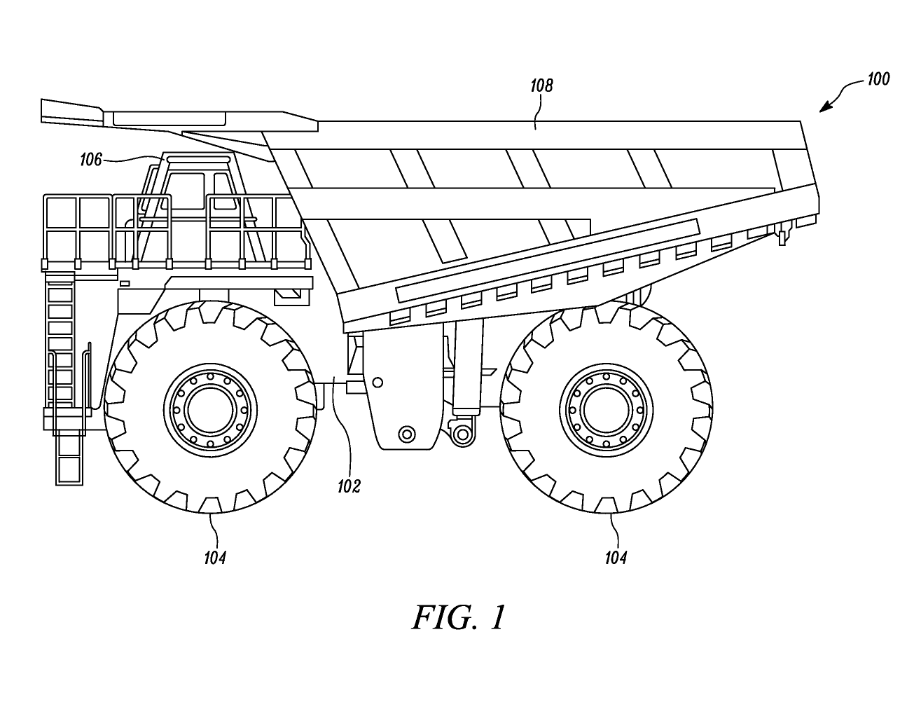

Reference will now be made in detail to specific aspects or features, examples of which are illustrated in the accompanying drawings. An exemplary embodiment of a machine 100, according to the present disclosure is shown in FIG. 1. The machine 100 is a mining truck. Alternatively, the machine 100 may include any off-highway or on-highway vehicle using a fuel-powered engine, as described herein. The machine 100 generally includes a frame 102 for supporting, among other systems and components. It should be understood that the machine 100 may embody any wheeled or tracked machine associated with mining, agriculture, forestry, construction, and other industrial applications.

The machine 100 includes an engine (not shown) associated therewith. The machine 100 also includes a plurality of ground-engaging elements 104, in this case being wheels. As should be appreciated by one of ordinary skill in the art, the engine may provide propulsion power to the ground-engaging elements 104 and may power a variety of other machine systems, including various mechanical, electrical, and hydraulic systems and/or components. Further, the machine 100 also includes an operator control station 106, including a variety of operator controls and displays useful for operating the machine 100 and/or a dump body or a payload carrier 108 which may be pivotal relative to the frame 102 of the machine 100.

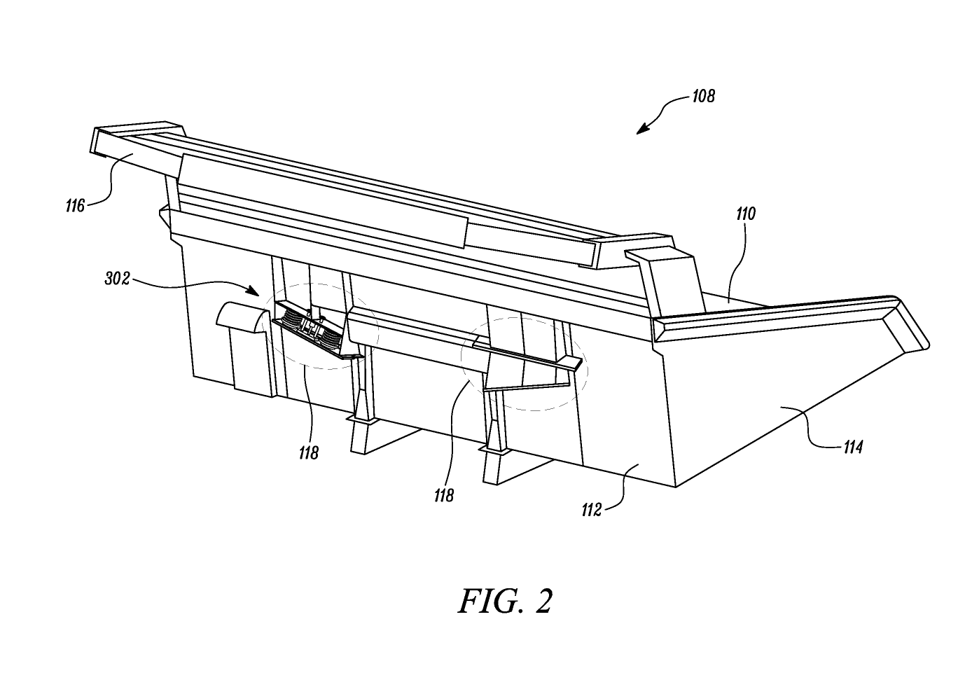

FIG. 2 is a perspective view of the payload carrier 108 of the machine 100. As shown, the payload carrier 108 includes a bed 110 configured to receive and dump material during loading and unloading cycle respectively. The payload carrier 108 has a back wall 112, a plurality of side walls 114 (only one shown), and a canopy portion 116. The back wall 112 includes a plurality of resting zones 118. The term “resting zones 118” used herein refers to those portions of the payload carrier 108 that rest against a suitable seating platform (not shown) provided on the frame 102 of the machine 100, and at a rear side of the operator control station 106.

Various kinds of external forces are exerted on the resting zones 118 during the operation of the machine 100. For example, the operation may include a loading cycle, an unloading cycle, or movement of the machine 100 on the ground, during which external forces or vibrations are exerted on the resting zones 118. The forces and vibrations as transferred to the resting zones 118 are capable of inducing stresses in the payload carrier 108, which may further lead to damage due to wear, and may further result in downtime of the machine 100. To counter such a situation, each of the resting zones 118 is provided with a suspension assembly 302. Each of the suspension assembly 302 of the resting zones 118 is protected by a cover 120 (only one shown for purpose of clarity) to safeguard internal components associated with the suspension assembly 302.

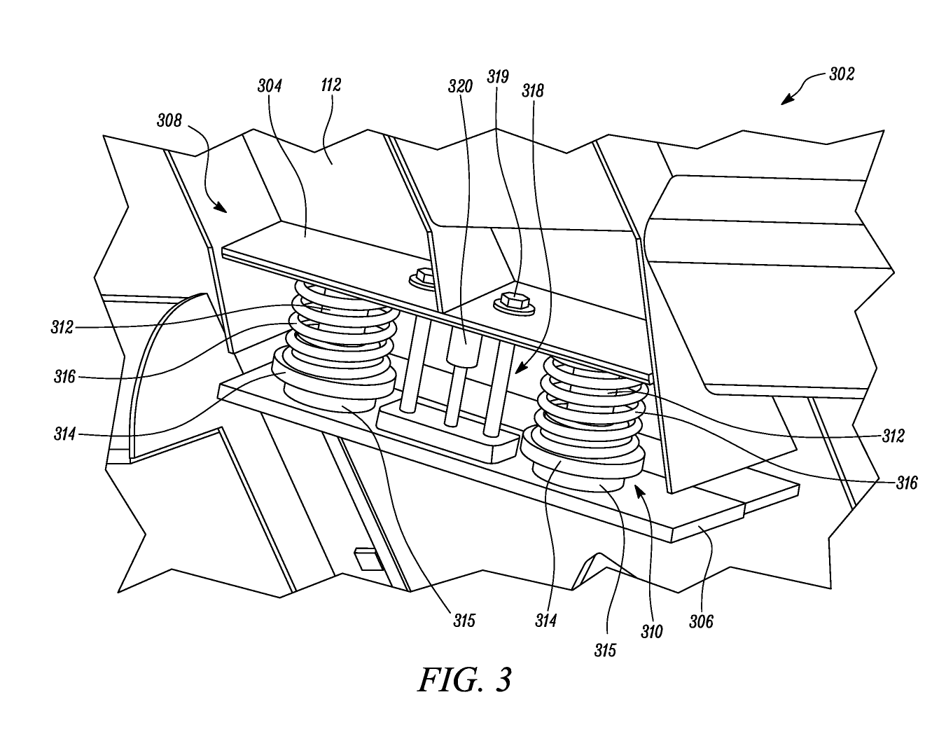

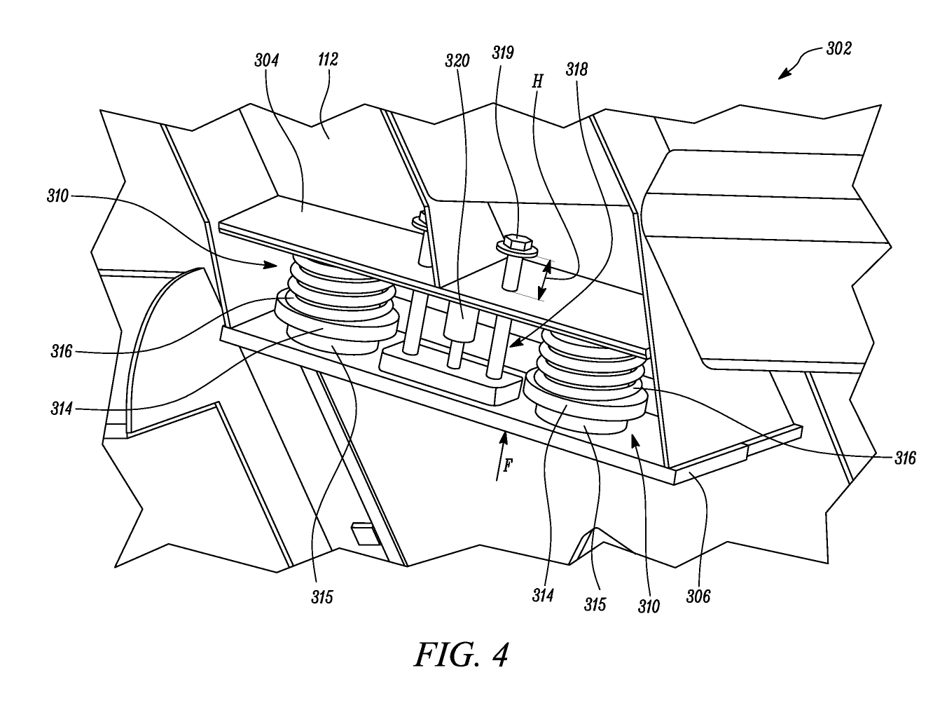

FIG. 3 illustrates a perspective view of the suspension assembly 302 provided at the resting zones 118, wherein no external force is being exerted on the suspension assembly 302. The suspension assembly 302 includes an upper plate 304 fixedly attached to the back wall 112 of the payload carrier 108. The upper plate 304 may be welded, mechanically fastened, or attached to the back wall 112 using known methods. The suspension assembly 302 further includes a lower plate 306 positioned laterally spaced apart from the upper plate 304 on the back wall 112 of the payload carrier 108. The lower plate 306 is configured to rest against the seating platform provided on the frame 102 of the machine 100 mentioned earlier. In context of the present disclosure, the lower plate 306 is configured to move relative to the upper plate 304 as the lower plate 306 rests on the seating platform, due to which an external force “F” (see FIG. 4) is exerted on the lower plate 306 in the direction of the upper plate 304.

The suspension assembly 302 includes a damper assembly 308. The damper assembly 308 is provided between the upper plate 304 and the lower plate 306. The damper assembly 308 is structurally and functionally configured to dampen vibrations and stresses induced in the lower plate 306. The damper assembly 308 includes a guiding element 310 fixedly attached to the upper plate 304, the lower plate 306, or both. The guiding element 310 includes a first guiding part 312 fixedly attached to the upper plate 304, and a second guiding part 314 fixedly attached to the lower plate 306. The first guiding part 312 and the second guiding part 314 constitute a male-female configuration, such that the second guiding part 314 is configured to receive the first guiding part 312. The second guiding part 314 further includes a support ring 315. The dimensions of a recess (not shown) of the second guiding part 314 receives the first guiding part 312 such that the first guiding part 312 moves relative to the second guiding part 314 on exertion of the external force “F” on the lower plate 306.

Referring to FIGS. 3 and 4, the damper assembly 308 further includes a spring member 316 provided in a surrounding relationship with the guiding element 310. The spring member 316 is supported on the support ring 315 of the second guiding part 314. The guiding element 310 is configured to guide a compression and extension of the spring member 316 along a length of the guiding element 310. The damper assembly 308 also includes a coupling mechanism 318 provided between the lower plate 306 and the upper plate 304. The coupling mechanism 318 includes a nut and bolt arrangement 319. The nut and bolt arrangement 319 is secured to the lower plate 306 through a stopper element 321 fixedly attached to the lower plate 306. The damper assembly 308 further includes a damping element 320 provided between the upper plate 304 and the lower plate 306. The damping element 320 is configured to dampen vibrations transferred to the suspension assembly 302, in view of the external force “F” being exerted on the lower plate 306.

FIG. 4 illustrates another perspective view of the suspension assembly 302, wherein the external force “F” is acting on the lower plate 306, and the spring member 316 is in a compressed state. In operation as mentioned earlier, as the payload carrier 108 descends after completing the unloading cycle, during movement of the machine 100, or during the loading cycle, the external force “F” is exerted on the lower plate 306. The lower plate 306 is configured to move towards the upper plate 304 on exertion of the external force “F”. Further, the external force “F” exerted on the lower plate 306 contemporaneously causes a compression of the spring member 316, along the length of the guiding element 310.

In an embodiment, the nut and bolt arrangement 319 of the coupling mechanism 318 is configured in such a way that the nut and bolt arrangement 319 move axially relative to the upper plate 304 on exertion of the external force “F” on the lower plate 306. The external force “F” moves the lower plate 306 towards the upper plate 304 by an effective height “H”. The effective height “H” may be corresponding to an extension of the nut and bolt arrangement 319 of the coupling mechanism 318 through the upper plate 304.

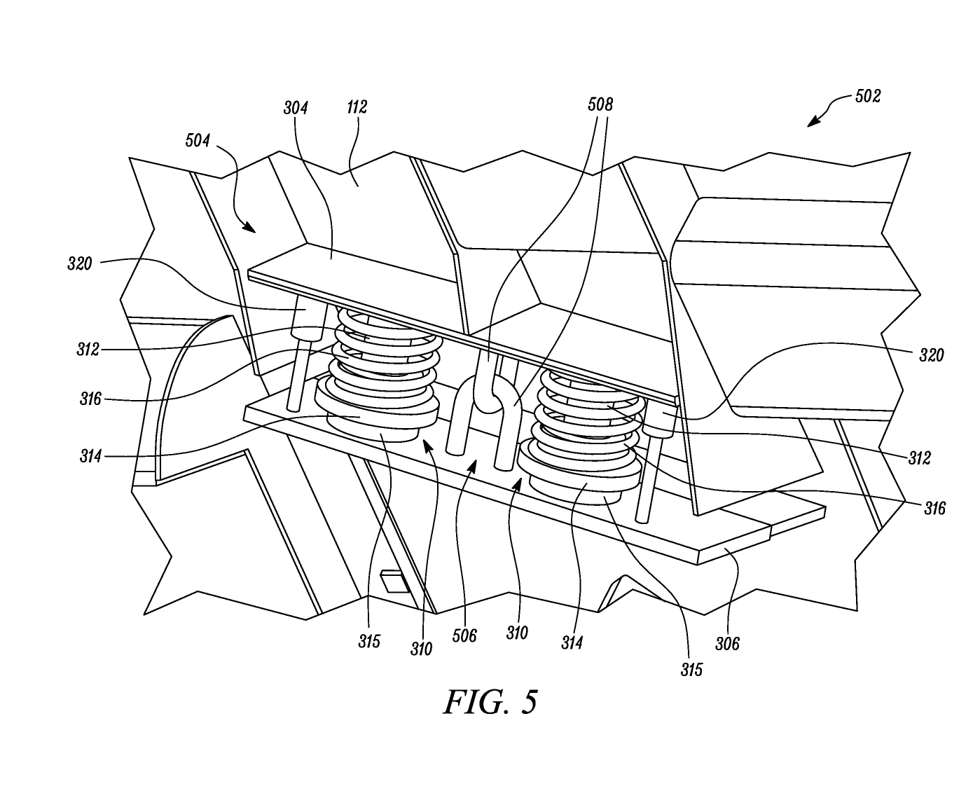

FIG. 5 illustrates a perspective view of a suspension assembly 502 according to another embodiment of the present disclosure, wherein no external force is being exerted on the suspension assembly 502. The suspension assembly 502 includes the upper plate 304, and the lower plate 306 positioned laterally spaced apart from the upper plate 304 on the back wall 112 of the payload carrier 108, similar in structure and function to the suspension assembly 302 described earlier. The suspension assembly 502 includes a damper assembly 504 provided between the upper plate 304 and the lower plate 306. The damper assembly 504 includes the guiding element 310, the spring member 316, and the damping element 320 similar in structure and function to the damper assembly 308 described earlier. The damper assembly 504 further includes a coupling mechanism 506 provided between the upper plate 304 and the lower plate 306. The coupling mechanism 506 includes a plurality of interlocking hooks 508, wherein each of the hooks 508 is fixedly attached to the upper plate 304 and the lower plate 306.

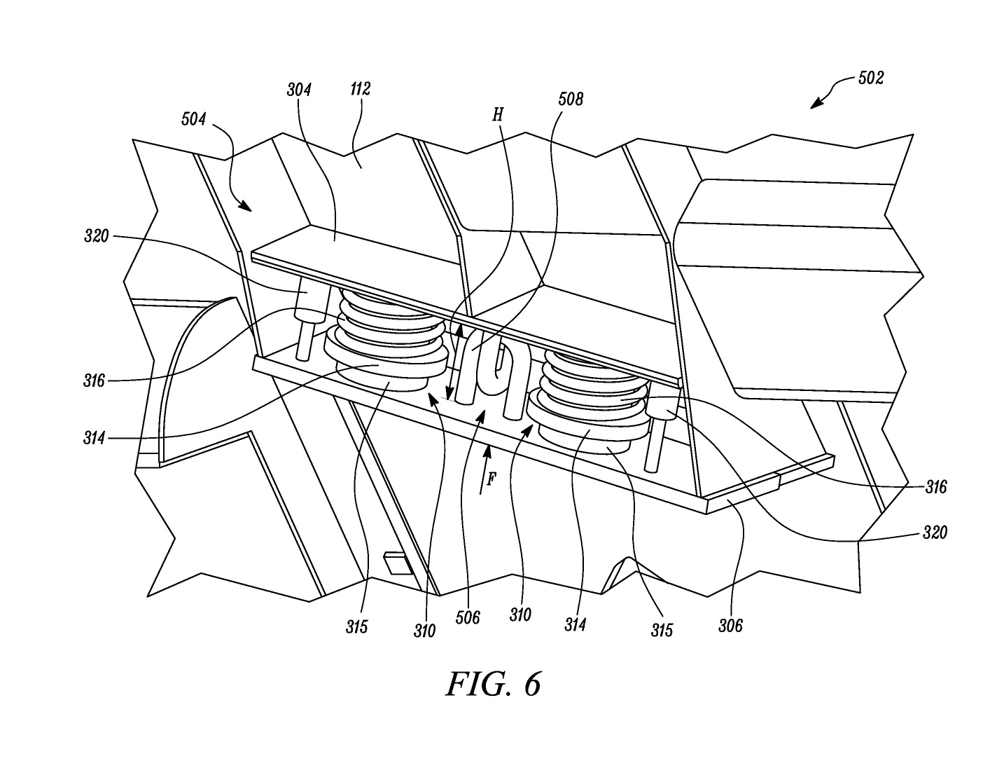

Referring to FIG. 6, when the external force “F” is acting on the lower plate 306 and the spring member 316 is in a compressed state. The hooks 508 of the coupling mechanism 506 are configured in such a way that the hooks 508 move towards each other on exertion of the external force “F” on the lower plate 306. The external force “F” moves the lower plate 306 towards the upper plate 304 by an effective height “H”. In an example, the effective height “H” is corresponding to depth of the hooks 508 of the coupling mechanism 506.

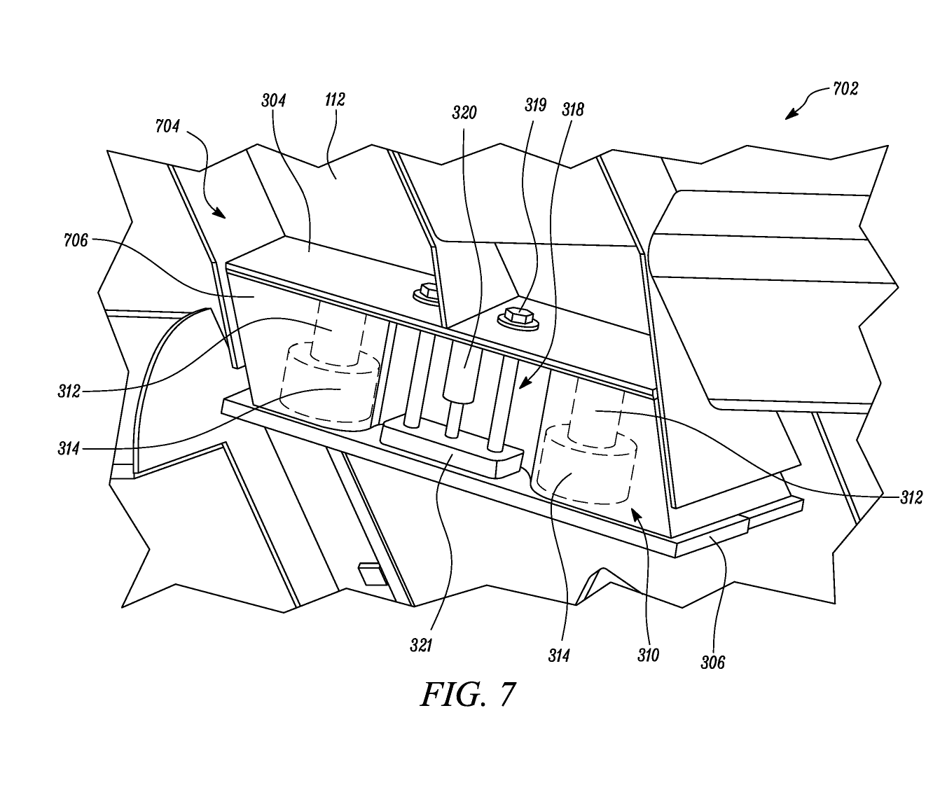

FIG. 7 illustrates a perspective view of a suspension assembly 702, according to another embodiment of the present disclosure, wherein no external force is being exerted on the suspension assembly 702. The suspension assembly 702 includes the upper plate 304, and the lower plate 306 positioned laterally spaced apart from the upper plate 304 on the back wall 112 of the payload carrier 108, similar in structure and function to the suspension assembly 302 described earlier. The suspension assembly 702 further includes a damper assembly 704 provided between the upper plate 304 and the lower plate 306. The damper assembly 704 includes the guiding element 310, and the coupling mechanism 318 similar in structure and function to the damper assembly 308 described earlier. The damper assembly 704 includes a damping element 706 provided between the upper plate 304 and the lower plate 306. The damping element 706 is an elastic flexible element fixedly attached to the upper plate 304 and the lower plate 306. The damping element 706 may be made of rubber, foam or any other flexible material of solid state. The damping element 706 is configured to compress and expand under loading and no-loading conditions respectively. Optionally, additional external damping elements 320 may also be provided between the upper plate 304 and the lower plate 306.

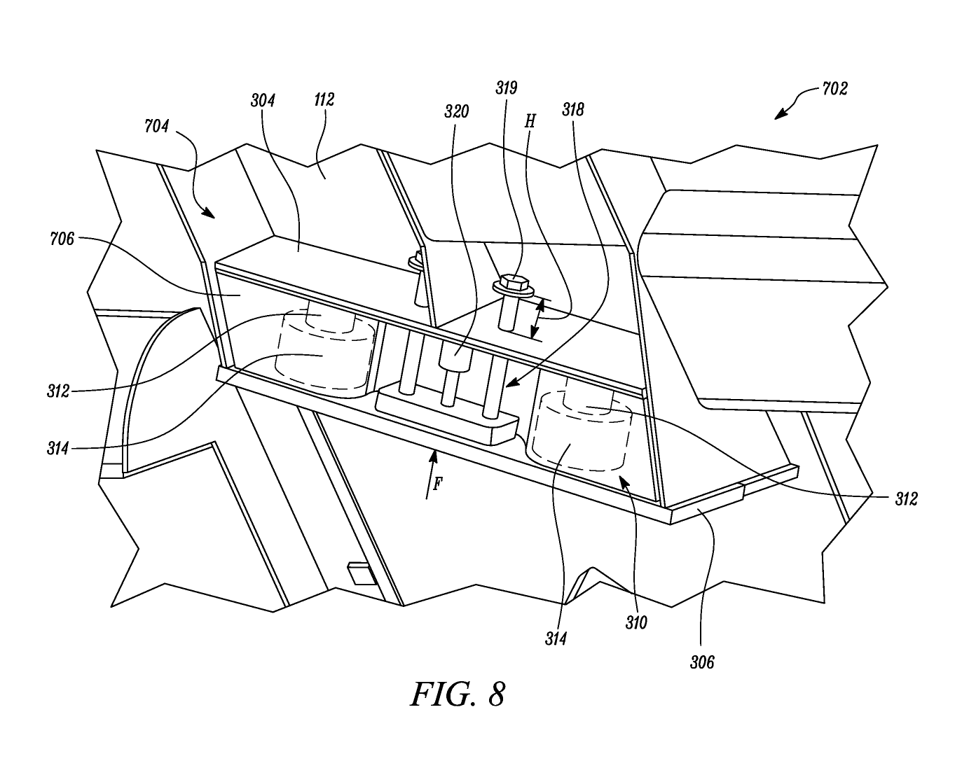

Referring to FIG. 8, when the external force “F” acts on the lower plate 306, and the damping element 706, and in turn the suspension assembly 702, the damping element 706 is in a compressed state. The external force “F” moves the lower plate 306 towards the upper plate 304 by an effective height “H” as shown. In an example, the effective height “H” is corresponding to a compression depth of the damping element 706, and in turn extension of the nut and bolt arrangement 319 of the coupling mechanism 318 through the upper plate 304 similar to FIG. 4, under influence of the external forces “F”.

### INDUSTRIAL APPLICABILITY

The industrial applicability of the suspension assembly 302, 502, 702 described herein will be readily appreciated from the foregoing discussion. As described earlier, the suspension assembly 302, 502, 702 includes the damper assembly 308, 504, 704 respectively. The damper assembly 308, 504, 704 includes a plurality of components, such as, the damping element 320 and the spring member 316 provided with the damper assembly 308, 504, and the damping element 706 provided with the damper assembly 704. Such plurality of components makes the suspension assembly 302, 502, 702 flexible in nature. Such flexible suspension assembly 302, 502, 702 is capable of dissipating vibrations and compensating induced stresses developed during the operation of the machine 100 under the influence of the external force “F”, thereby reducing wear and tear associated with the payload carrier 108. The suspension assembly 302, 502, 702 provides a joint that is a flexible movable joint at the resting zones 118 that may absorb sudden impact or shock that the payload carrier 108 may be subject to. Thus, by allowing the payload carrier 108 to move by the effective height “H” (see FIGS. 4, 6, 8) the suspension assembly 302, 502, 702 may dampen the effect of the external force “F” acting on the payload carrier 108.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A suspension assembly for a payload carrier, the payload carrier having a bed, the suspension assembly comprising:
an upper plate fixedly attached to a back wall of the payload carrier;
a lower plate positioned laterally spaced apart from the upper plate on the back wall of the payload carrier, wherein the lower plate is configured to move relative to the upper plate; and
a damper assembly provided between the upper plate and the lower plate, the damper assembly comprising:
a guiding element fixedly attached to at least one of the upper plate or the lower plate;
a stopper element fixedly attached to at least one of the upper plate or the lower plate;
a spring member provided surrounding the guiding element, wherein the guiding element is configured to guide a compression and extension of the spring member along a length of the guiding element; and
a coupling mechanism provided between the lower plate and the upper plate, the coupling mechanism configured to couple the lower plate with the upper plate,
wherein the lower plate is configured to move towards the upper plate on exertion of an external force thereon, the external force contemporaneously causing a compression of the spring member along the length of the guiding element for moving the lower plate towards the upper plate by an effective height,
wherein the damper assembly is configured to dampen a transfer of the external force from the lower plate to the upper plate.
